(19) United States
(12) Patent Application Publication
(10) Pub. No.: US 2006/0139493 A1
(43) Pub. Date: Jun. 29, 2006

(54) Displaying apparatus and control method thereof

(75) Inventor: Young-chan Kim, Uiwang-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/254,688

(22) Filed: Oct. 21, 2005

(30) Foreign Application Priority Data
Dec. 24, 2004 (KR) 2004-0111867

(51) Int. Cl. H04N 5/44; H04N 5/14

(52) U.S. Cl. 348/576; 348/553

(57) ABSTRACT

The present invention relates to a displaying apparatus having a display unit for displaying thereon an active image according to an image signal supplied from a predetermined signal source, comprising a capture setting unit for setting a predetermined capture area to be captured in the active image displayed on the display unit; a capture block unit for capturing image data within the set capture area in the image data activated as the active image; and a control unit for controlling the capture block unit to capture the image data of the active image corresponding to the set capture area. Thus, the present invention provides a displaying apparatus capable of capturing an active image displayed on the display unit as it is actually viewed by a user, and also capturing a partial area in the active image with the shape as desired by the user, and a control method thereof.

### CROSS-REFERENCE TO RELATED APPLICATIONS

This application claims the benefit under 35 U.S.C. §119(a) of Korean Patent Application Serial No. 2004-0111867, filed on Dec. 24, 2004, in the Korean Intellectual Property Office, the entire disclosure of which is hereby incorporated by reference.

### BACKGROUND OF INVENTION

1. Field of Invention

The present invention relates to a displaying apparatus and a control method thereof. More particularly, the present invention relates to a displaying apparatus capable of capturing an area desired by a user in a displayed active image and a control method thereof.

2. Description of the Related Art

Generally a displaying apparatus provides an activated image by processing an image signal from a predetermined signal source so that a user can view it. Accordingly, a displaying apparatus comprises a signal processing unit for processing an input image signal, a conversion unit (for example, a scaler) for converting the image signal supplied from the signal processing unit to be in a format displayable on a display unit, the display unit for displaying an active image according to the converted image signal, and a control unit for controlling operations thereof.

In capturing an active image displayed on a general displaying apparatus, a desired area is captured by use of a capture utility program provided in a computer as a kind of signal source for providing an image signal. At this time, images in the formats of a picture in picture (PIP) or a picture by picture (PBP) may be displayed as overlapped on the display unit of the displaying apparatus. To adjust picture quality or settings of the displaying apparatus, an on screen display (OSD) image may be displayed on the display unit by the displaying apparatus, separately from an image signal from a predetermined signal source.

Where an OSD image of the displaying apparatus or a PIP-format image is activated and displayed as overlapped under the condition that image data according to an image signal from a signal source is displayed on the display unit as an active image, the OSD image or the PIP-format image is not captured although an image on the display unit is captured by a capture utility program provided in the computer. In other words, since the displaying apparatus is constructed so that only an image according to an image signal input from a signal source (such as a computer) can be captured, an active image output and displayed on the display unit of the displaying apparatus is not captured as it is.

In addition, the conventional displaying apparatus is constructed so that the whole area of a frame image displayed on a screen is collectively captured and stored when capturing an active image displayed on the display unit. Thus, unnecessary areas of the image may also be captured. For this reason, the displaying apparatus needs a large capacity internal memory to store the captured image, thereby lowering an efficiency of utilizing the memory. Further, a separate operation is needed to remove the unnecessary portion of the captured area, thereby causing an inconvenience in using it.

### SUMMARY OF THE INVENTION

Accordingly, it is an object of the present invention to provide a displaying apparatus capable of capturing an active image displayed on the display unit as it is actually viewed by a user, and also of capturing a partial area in the active image with a shape as desired by the user, and a control method thereof.

Additional objects and/or advantages of the invention will be set forth in part in the description which follows and, in part, will be obvious from the description, or may be learned by practice of the invention.

The foregoing and/or other objects of the present invention are achieved by providing a displaying apparatus having a display unit for displaying thereon an active image according to an image signal supplied from a predetermined signal source. The display unit comprises a capture setting unit for setting a predetermined capture area to be captured in the active image displayed on the display unit; a capture block unit for capturing image data within the set capture area in the image data activated as the active image; and a control unit for controlling the capture block unit to capture the image data of the active image corresponding to the set capture area.

According to an aspect of the present invention, the displaying apparatus further comprises a capture memory for storing therein the image data of the capture area captured by the capture block unit.

According to an aspect of the present invention, the active image is displayed according to image data based on different image signals supplied from different signal sources.

According to an aspect of the present invention, the active image includes an OSD image displayed according to predetermined OSD image data on the display unit.

According to an aspect of the present invention, the capture setting unit is embodied as an interface screen according to an OSD image displayed on the display unit.

According to an aspect of the present invention, the capture setting unit is embodied as a predetermined utility program.

According to an aspect of the present invention, the capture setting unit is embodied as a general purpose input device.

According to an aspect of the present invention, the capture area is set up with a section block according to predetermined coordinate values relative to the active image.

According to an aspect of the present invention, the capture area is set up with a plurality of section blocks.

According to an aspect of the present invention, the capture area is set up so that the section block has an arbitrary shape.

According to an aspect of the present invention, the control unit converts coordinate values of the capture area according to an input resolution into coordinate values thereof according to a display resolution, to allow the capture block unit to capture the image data corresponding to the capture area, where the input resolution of the image signal and the display resolution set up on the display unit are different from each other.

The foregoing and/or other aspects of the present invention are achieved by providing a control method of a displaying apparatus having a display unit for displaying thereon an active image according to an image signal supplied from a predetermined signal source, comprising the steps of setting up a predetermined capture area to be captured in an active image displayed on the display unit with section blocks according to predetermined coordinate values; capturing image data within the set capture area according to a capture executing command to the image data activated the active image; and storing the captured image data.

According to an aspect of the present invention, the control method further comprises capturing the image data corresponding to the capture area by converting coordinate values of the capture area according to an input resolution into coordinate values thereof according to a display resolution, where the input resolution of the image signal and the display resolution set up on the display unit are different from each other.

### BRIEF DESCRIPTION OF THE DRAWINGS

These and other aspects and advantages of the present invention will become apparent and more readily appreciated from the following description of exemplary embodiments, taken in conjunction with the accompany drawings of which:

FIG. 1 is a block diagram illustrating a schematic configuration of a displaying apparatus according to an embodiment of the present invention;

FIG. 2 is a diagram illustrating setting a capture area in a displaying apparatus according to an embodiment of the present invention;

FIG. 3 is a diagram illustrating a capture area in a displaying apparatus according to an embodiment of the present invention;

FIG. 4 is a diagram illustrating conversion of a capture area set up according to an embodiment of the present invention;

FIG. 5 is a control flow chart when employing a capture utility program of a displaying apparatus according to an embodiment of the present invention; and

FIG. 6 is a control flow chart illustrating a method of capturing an image of a capture area in a displaying apparatus according to an embodiment of the present invention.

Throughout the drawings, like reference numbers will be understood to refer to like elements, features, and structures.

### DETAILED DESCRIPTION OF EXEMPLARY EMBODIMENTS

Reference will now be made in detail to exemplary embodiments of the present invention, examples of which are illustrated in the accompanying drawings.

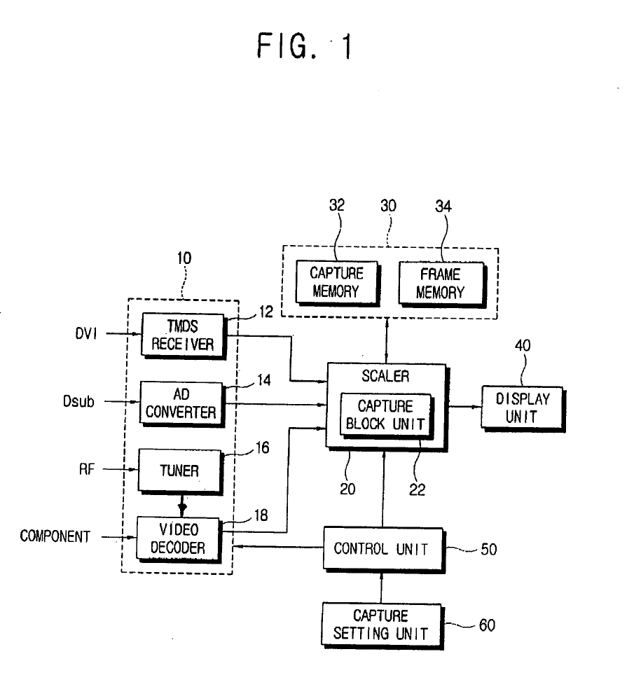

FIG. 1 is a block diagram illustrating a schematic configuration of a displaying apparatus according to an exemplary embodiment of the present invention. As illustrated, the displaying apparatus according to an embodiment of the present invention comprises a signal processing unit 10, a scaler 20, a capture block unit 22, a memory unit 30, a display unit 40, a control unit 50 and a capture setting unit 60.

The signal processing unit 10 converts an image signal received from a predetermined signal source into an image signal available for processing by the scaler 20. The signal processing unit 10 may comprise a transition minimized differential signaling (TMDS) receiver 12, an A/D converter 14, a tuner 16, a video decoder 18 and so on, so as to process image signals from various signal sources. Image signals from various signal sources may include a signal from a computer, an RF broadcasting signal, a video signal from a DVD apparatus or a set-top box, and the like, which may be displayed in PIP or PBP formats on the display unit 40.

The TMDS receiver 12 divides a digital video signal such as a digital video interface (DVI) signal received externally through a digital connection terminal into an RGB digital signal and an H/v synchronous signal and outputs them to the scaler 20. The A/D converter 14 converts an analog video signal such as a PC signal received through a D-sub connector or the like into a digital video signal and outputs it to the scaler 20. The video decoder 18 decodes a component signal received from an analog connection terminal, or an analog video signal including a composite video broadcast signal (CVBS) or S-video signal and outputs them to the scaler 20. The tuner 16 receives an RF signal received from an antenna (not shown) and so on, for example, a broadcast signal, and outputs it to the video decoder 18.

The scaler 20 processes an image signal supplied from the signal processing unit 10 into a format displayable on the display unit and outputs it. Herein, the scaler 20 may be configured so that it displays an image corresponding to a predetermined image signal supplied from the signal processing unit on the display unit 40, or a composite image such as a PIP or PBP-format image on the display unit 40, based on control by the control unit 50. Accordingly, a processing device to process a PIP or PBP-format image may be provided within the scaler 40 or may be provided as a separate device from the scaler 40. Where the capture block unit 22 is included in the scaler 20, image data corresponding to a predetermined capture area may be captured from image data of an image signal supplied from the signal processing unit 10 and stored in the memory unit 30, based on control by the control unit 50.

The capture block unit 22 is constructed so that image data within a predetermined capture area as set up can be captured in the image data displayed as an active image on the display unit 40. The predetermined capture area to be captured in active images displayed on the display unit 40 may be set up by the capture setting unit 60. At this time, the control unit 50 may control the capture block unit 22 so that image data of an active image corresponding to the set capture area can be captured by the capture block unit 22.

In an exemplary embodiment as illustrated in FIG. 1, the capture block unit 22 is included within the scaler 40, but the capture block unit 22 may also be separate from the scaler 40. The capture block unit 22 is provided as a separate device from the scaler 40 so as to make control by the control unit 50 more convenient.

The image data corresponding to the predetermined capture area captured by the capture block unit 22 is stored in the memory unit 30. The memory unit 30 may be constructed to include therein a capture memory 32 to store only an image data corresponding to a capture area. Also, the memory unit 30 may further comprise a frame memory 34 to store frame image data displayed as an active image.

The display unit 40 receives an image signal converted to be in any appropriate format by the scaler 20 and displays it as an active image so as to allow a user to view it. The display unit 40 may comprise a display panel on which an image is displayed, and a panel driving unit for processing an image signal received from the scaler 20 and displaying an image on the display panel. At this time, various panels such as a liquid crystal display (LCD), a plasma display panel (PDP), an organic light emitting diode (OLED), and so on may be adopted as a display panel, and a panel driving unit corresponding to each type of panel may be provided.

A displaying apparatus according to an exemplary embodiment of the present invention may further comprise a user input unit (not shown) for outputting a predetermined key signal to the control unit 50 according to a user's manipulation.

The user input unit may comprise a control button provided in front of the displaying apparatus, and a key signal generating unit for generating a key signal corresponding to a key manipulation of the control button. The user input unit may be a general purpose input unit separately provided, such as a mouse, a keyboard, a stylus pen or a wireless remote control, or a touch screen. When a user manipulates the control button, the key signal generating unit generates a key signal corresponding to the key manipulation and supplies it to the control unit 50. The control unit 50 may control the scaler 20 and the capture block unit 22, the signal processing unit 10 and so on, corresponding to the key signal inputted from the key signal generating unit.

In addition, the displaying apparatus may be constructed so that the user can set up a predetermined capture area from an active image displayed on the display unit, by adopting the various user input units described above as the capture setting unit 60. In other words, when a capture function associated with an active image is selected according to manipulation by the user, the desired capture area may be set up by controlling a mouse pointer or a predetermined key provided on a keyboard, or the like.

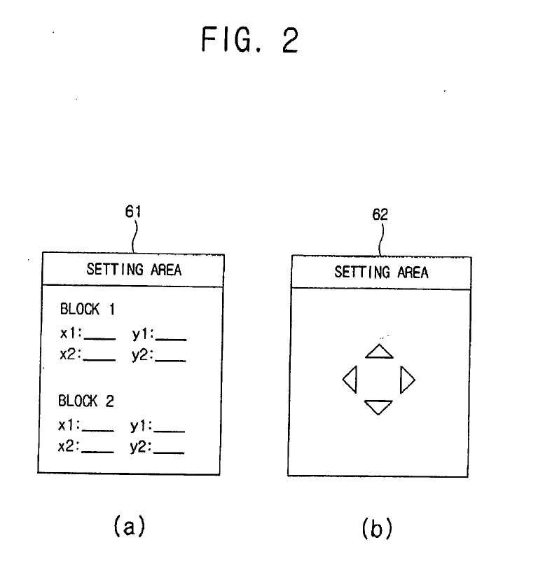

The capture setting unit 60 may provide interface screens 61 and 62 (see FIG. 2) to set up a predetermined capture area 43 in an active area 41 of an active image displayed on the screen of the display unit. The capture area 43 desired by the user may be set up by use of the interface screens 61 and 62 associated with an active image displayed on the display unit 40. In this case, the capture setting unit 60 is enabled by use of the interface screens 61 and 62. Also, the interface screens 61 and 62 may be embodied as an OSD image according to OSD image data provided from an OSD generating unit (not shown). By use of an OSD button provided on a predetermined area of the displaying apparatus, an OSD image is displayed, comprising a menu to set up a capture area in addition to menus to set up the picture quality and other settings.

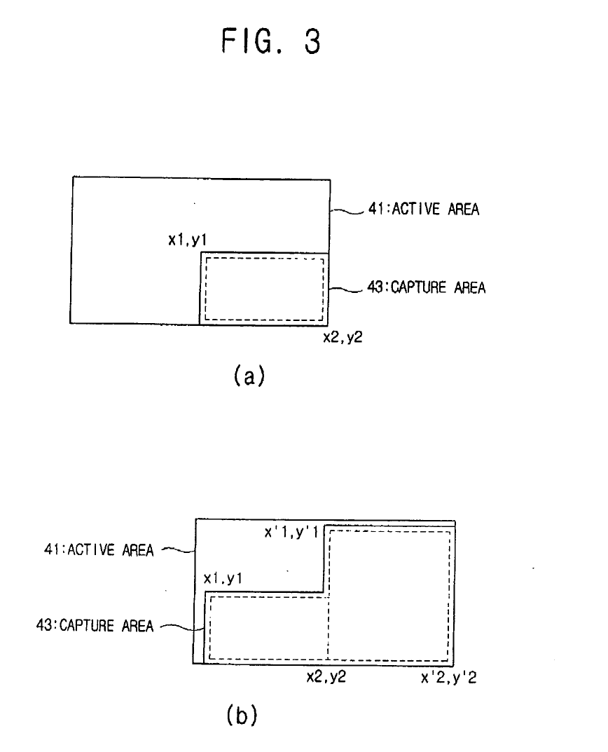

The interface screen 61 to set up a capture area illustrated in FIG. 2A allows a user to directly input coordinate values of the desired capture area. To capture an area sectioned with a section block (for example, Block 1), start coordinates (for example, x1 and y1) and end coordinates (for example, x2 and y2) of x axis and y axis relative to an active image are designated. Accordingly, the block area sectioned based on the designated start coordinates and end coordinates is set as a capture area. As illustrated in FIGS. 3A and 3B, the capture area 43 according to the set coordinate values in the active area 41 of the active image may be indicated by a predetermined capture setting line (for example, a dotted line). In this case, when a mouse is used as a general purpose input device as described above, the capture area may be set by clicking a mouse pointer and dragging it from the start coordinates to the end coordinates. To set the capture area 43 including a plurality of section blocks as illustrated in FIG. 3B, it is possible to set up the capture area by designating separate start coordinates (X1 and Y1) and end coordinates (X2 and Y2) relative to Block 2 in addition to Block 1 in the interface screen 61.

Without directly inputting coordinate values associated with the capture area 43, the predetermined capture area 43 may be set up by moving a predetermined capture setting line to a desired position or adjusting the size of an area according to the capture setting line by manipulating a four-direction key displayed on the interface screen 62. In this case, when a keyboard is used as a general purpose input device and as a capture setting unit 60, the direction keys provided in the keyboard can be manipulated as movement keys corresponding to the interface screen 62.

Where an input resolution of an image signal set as an active image on the display unit and a display resolution set up to display the image signal on the display unit are different from each other, the control unit 50 may be constructed so that the capture block unit 22 can capture image data corresponding to the capture area set up by converting the coordinate values of the capture area according to the input resolution into the coordinate values according to the display resolution of the display unit 40.

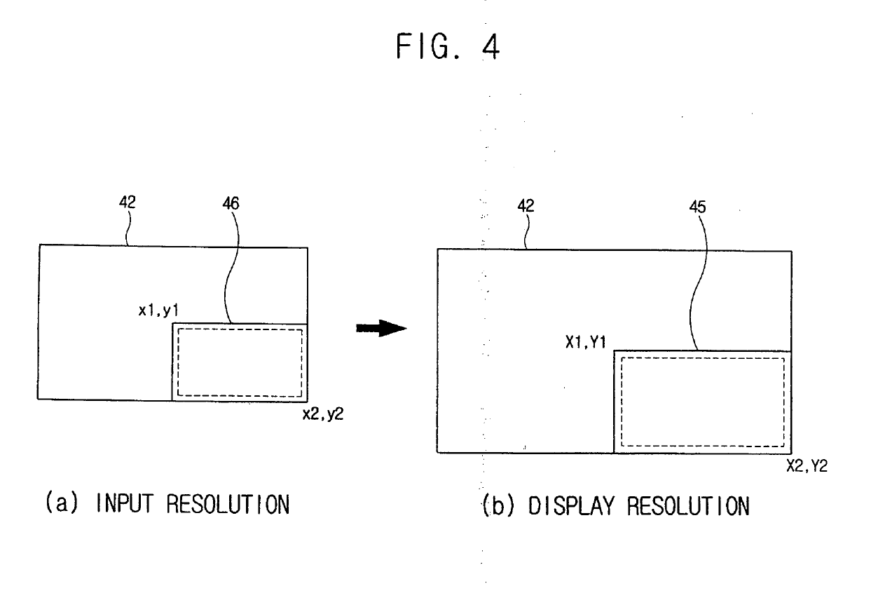

For example, assume that in FIG. 4A a capture area 46 is set up in an active area 42 of an active image having the input resolution of 640×480. At this time, when the active area 41 of an active image having a display resolution of 1280×1024 is provided as in FIG. 4B, the display unit 40 of the displaying apparatus converts the coordinate values of the capture area 46 in FIG. 4A corresponding to the coordinate values of the capture area 45 in FIG. 4B. In other words, if the coordinates (x1, y1), (x2, y2) of the capture area 46 are converted into the coordinates (X1, Y1), (X2, Y2) of the capture area 45, the converted values of respective start and end coordinates may be obtained based on a formula such as 640:x1=1280:X1,X1=(1280*x1)/640.

As described above, the capture area 43 according to the predetermined section block as desired by the user may be designated from image data of the active area 41 activated in the active image displayed on the display unit, by use of the capture setting-unit 60 constructed in various methods as described above. In addition, the capture area may be designated with an arbitrary shape. Further, the capture area may be set up by capturing a window corresponding to a PIP-format or PBP-format image or only a window corresponding to an OSD image displayed on the display unit 40.

In addition, an image signal corresponding to the interface screens 61 and 62 provided as an OSD image to set up an area desired by the user with the capture setting unit 22 may be displayed on the display unit 40 as mixed with another image signal supplied from the scaler 20 through the control of the control unit 50. The OSD generating unit may be included in the scaler 20 or may be provided separately from the scaler 20 to display interface screens 61 and 62 used by the user as the capture setting unit 60.

When a capture setting function is selected through manipulation by the user input unit, the control unit 50 controls the scaler 20 so that the entire active image is displayed as an active area of the received image signal. The control unit 50 further displays the interface screens 61 and 62 of the capture setting unit 60 to set up a capture area over the entire active image displayed as an active area on the display unit 40.

The control unit 50 provides the capture block unit 22 with information regarding the capture area set up by the capture setting unit 60. Accordingly, the capture block unit 22 determines whether image data provided as an active image corresponds to the image data included in the set capture area. The control unit 50 controls capturing so that the image data corresponding to the capture area set up by the capture block unit 22 is captured and stored in the capture memory 32.

In a displaying apparatus according to an exemplary embodiment of the present invention, image data corresponding to the capture area set up in the active image which is displayed on the display unit 40 and actually viewed by the user may be stored as is.

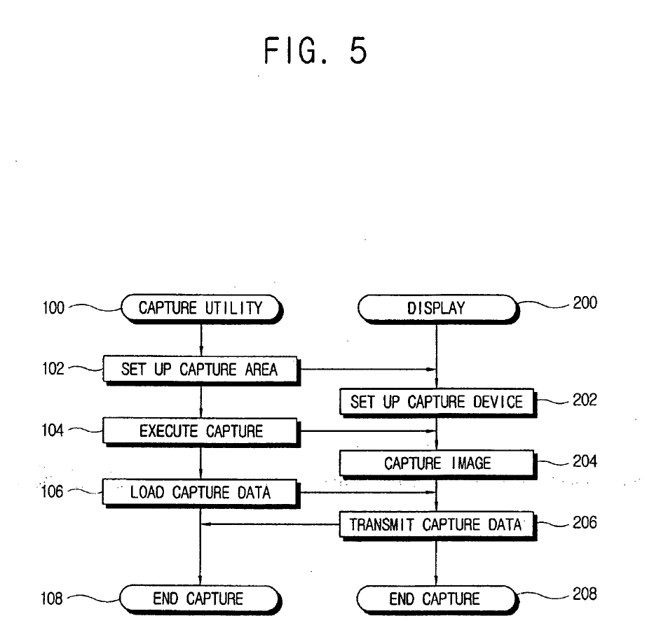

Now a method of capturing an image signal-according to an embodiment of the present invention will be described with reference to FIG. 5. The capture setting unit 60 may be embodied by executing the capture utility program at operation S100. That is, a control signal according to execution of the capture utility program is provided to the control unit 50 of the displaying apparatus whereby a capture function associated with the image data as described above can be executed. At this time, the capture utility program may be constructed so that the interface screens 61 and 62 to execute the capture function are executed in a computer or the like and supplied through the display unit 40.

Accordingly, with respect to an image displayed on the display unit 40 of the displaying apparatus, the user is allowed to set up a predetermined capture area by use of the capture utility program at operation S102. The displaying apparatus configures the capture function to execute by providing information regarding the capture area to be used by the capture utility program in the control unit 50. A capture device (for example, the capture block unit 22), captures image data corresponding to a capture area relative to an image displayed at operation S202. When a command to execute the capture is provided by use of the capture utility program after setting up the capture area at operation S104. The control unit 50 of the displaying apparatus allows the capture block unit 22 to capture the corresponding capture area at operation 204. At this time, the capture block unit 22 determines whether the image data provided as described above corresponds to the capture area and allows the captured image data to be stored in the capture memory 32. When a command to load the captured image data is applied from the capture utility program at operation S106, the control unit 50 of the displaying apparatus transmits the image data corresponding to the set capture area stored in the capture memory 32 so that the capture utility program can manage it at operation S206. Accordingly, the capture operation of a predetermined capture area is completed at operations S108 and S208. The captured image data may be provided for a predetermined operation by executing the capture utility program.

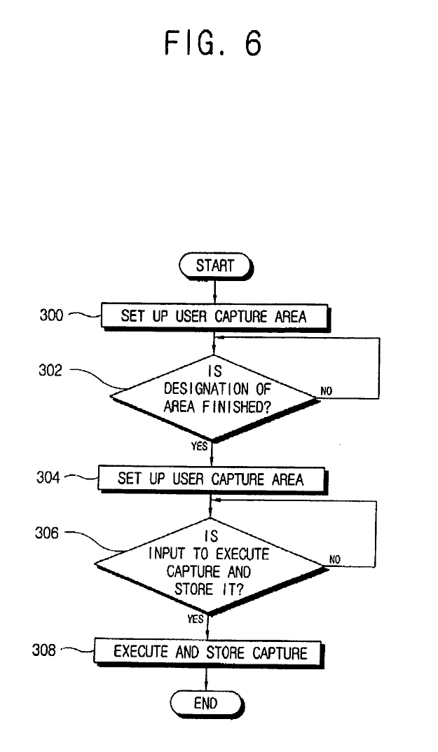

A control flow of the whole operation wherein a capture function is executed in the displaying apparatus according to an exemplary embodiment of the present invention will now be described with reference to FIG. 6.

A capture area desired by a user is set up through the capture setting unit 60 at operation S300. This setting operation may be embodied through various methods as described above. When designation of the desired capture area is completed at operation S302, the control unit 50 provides information regarding the capture area to a capture device (for example, a capture block unit 22) and sets up the capture device so as to capture the image data. Accordingly, the control unit 50 determines whether a command to execute capturing of the set capture area and an input signal to store the capture image data are applied at operation S306. The control unit 50 captures image data according to the set capture area to the active image actually displayed on the display unit 40 through the capture block unit 22 as desired by the user and stores it in the capture memory 32 at operation S308. A specific capture operation has been described above. Coordinate conversion to the set capture area may be performed taking into consideration the display resolution of the display unit 40 when executing the capture as described above.

At this time, without requiring a separate command for capture execution and storage, the control unit 50 can capture image data of an actual active image corresponding to the capture area set up by the user and store it in the capture memory 32.

Where information regarding the capture area is set up in advance through the capture setting unit 60 and a capture function to the active image is selected through the user input unit, a device according to an embodiment of the present invention can advantageously capture and store only the image data corresponding to the capture area selected by the user.

The displaying apparatus according to an exemplary embodiment of the present invention may enhance a user's convenience by setting up, in a simple manner, a desired capture area in image data of an active image as actually viewed by the user, based on an image signal supplied from a predetermined signal source displayed on the display unit, and storing the image data of the concerned capture area. In addition, since predetermined image data as desired, not the entire active image displayed on the display unit is captured, the memory capacity may be reduced and an efficiency of capture is increased.

In a displaying apparatus according to an exemplary embodiment of the present invention described above, various image signals from signal sources are digitized in the signal processing unit, supplied to the scaler, and displayed on the display unit, by way of example. In addition, embodiments of the present invention may be applied to a displaying apparatus that displays an analog image signal, such as a cathode ray tube (CRT). The displaying apparatus and a control method thereof according to an embodiment of the present invention may also be applicable to a projection-type displaying apparatus as well as a direct view-type displaying apparatus.

According to the displaying apparatus and a control method thereof according to embodiments of the present invention, an active image may be captured as displayed on the display unit and actually viewed by a user, and a partial area may be captured by setting up a capture area as desired by the user in the actual active image.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A displaying apparatus having a display unit for displaying thereon an active image according to an image signal supplied from a predetermined signal source, comprising:
a capture setting unit for setting a predetermined capture area to be captured in the active image displayed on the display unit;
a capture block unit for capturing image data within the set capture area in the image data activated as the active image; and
a control unit for controlling the capture block unit to capture the image data of the active image corresponding to the set capture area.

2. The displaying apparatus according to claim 1, further comprising a capture memory for storing therein the image data of the capture area captured by the capture block unit.

3. The displaying apparatus according to claim 1, wherein the active image displayed comprises image data based on different image signals supplied from different signal sources.

4. The displaying apparatus according to claim 3, wherein the active image includes an OSD image displayed by predetermined OSD image data on the display unit.

5. The displaying apparatus according to claim 1, wherein the capture setting unit is embodied as an interface screen according to an OSD image displayed on the display unit.

6. The displaying apparatus according to claim 1, wherein the capture setting unit is embodied as a predetermined utility program.

7. The displaying apparatus according to claim 1, wherein the capture setting unit is embodied as a general purpose input device.

8. The displaying apparatus according to claim 1, wherein the capture area is set up with a section block according to predetermined coordinate values relative to the active image.

9. The displaying apparatus according to claim 8, wherein the capture area is set up with a plurality of section blocks.

10. The displaying apparatus according to claim 8, wherein the capture area is set up so that the section block has an arbitrary shape.

11. The displaying apparatus according to claim 8, wherein the control unit is adapted to convert coordinate values of the capture area according to an input resolution into coordinate values thereof according to a display resolution, to allow the capture block unit to capture the image data corresponding to the capture area, where the input resolution of the image signal and the display resolution set up on the display unit are different from each other.

12. The displaying apparatus according to claim 1, wherein the active image includes an OSD image displayed by predetermined OSD image data on the display unit.

13. A control method of a displaying apparatus having a display unit for displaying thereon an active image according to an image signal supplied from a predetermined signal source, comprising:
setting up a predetermined capture area to be captured in an active image displayed on the display unit with section blocks according to predetermined coordinate values;
capturing image data within the set capture area according to a capture executing command from the image data of the active image; and
storing the captured image data.

14. The control method according to claim 13, further comprising capturing the image data corresponding to the capture area by converting coordinate values of the capture area according to an input resolution into coordinate values thereof according to a display resolution, where the input resolution of the image signal and the display resolution set up on the display unit are different from each other.
